(19) United States
(12) Patent Application Publication
(10) Pub. No.: US 2011/0138418 A1
(43) Pub. Date: Jun. 9, 2011

(54) APPARATUS AND METHOD FOR GENERATING PROGRAM SUMMARY INFORMATION REGARDING BROADCASTING CONTENT, METHOD OF PROVIDING PROGRAM SUMMARY INFORMATION REGARDING BROADCASTING CONTENT, AND BROADCASTING RECEIVER

(76) Inventors: Yoon-Hee Choi, Suwon-si (KR); II-Hwan Choi, Yongin-si (KR); Chang-Hwan Choi, Seoul (KR)

(21) Appl. No.: 12/957,823

(22) Filed: Dec. 1, 2010

(30) Foreign Application Priority Data
Dec. 4, 2009 (KR) 10-2009-0119889

(51) Int. Cl. H04N 5/445

(52) U.S. Cl. 725/40

(57) ABSTRACT

An apparatus and method of receiving broadcasting content and generating program summary information corresponding to received broadcasting content, and an apparatus and method of providing the generated program summary information are provided. Real-time broadcasting content may be received through a tuner of a program summary information generating apparatus. The program summary information is extracted from the received real-time broadcasting content, and may be stored and provided to a user via a display unit. In view of the program summary information, a user may understand, for example, the flow of the broadcasting content, even if the user missed a part of the broadcasting content.

### CROSS-REFERENCE TO RELATED APPLICATION

This application claims the benefit under 35 U.S.C. §119(a) of Korean Patent Application No. 10-2009-0119889, filed on Dec. 4, 2009, the disclosure of which is incorporated by reference in its entirety for all purposes.

### BACKGROUND

1. Field

The following description relates to an apparatus and method capable of receiving broadcasting content and generating program summary information regarding the received broadcasting content, and an apparatus and method for providing the generated program summary information.

2. Description of the Related Art

When an operator turns on a broadcast receiving device such as a television to watch real-time broadcasting content, the operator may encounter a part of the program other than the beginning part of the program. In this case, the operator has not been made aware of information of the part of the program, generated before the program was turned on. Accordingly, the operator might find it difficult to figure out the outline of the program.

In addition, the operator may fall into a similar situation when a channel is changed from a channel ‘A’ to a channel ‘B.’

### SUMMARY

Accordingly, according to one aspect, when content such as a broadcasting program is received, in order for an operator to understand general information regarding a previously broadcast part of a program, program summary information of the broadcasting content is generated and provided to the operator.

According to another aspect, there is provided an apparatus and method capable of generating program summary information regarding real-time broadcasting content.

In still another aspect, there is provided an apparatus and method capable of providing program summary information regarding real-time broadcasting content.

In still another aspect, there is provided a method of generating program summary information in a program summary information generating apparatus including at least one tuner, the method including receiving real-time broadcasting content through the tuner, extracting the program summary information from the received real-time broadcasting content, and storing the extracted program summary information.

The extracting of the program summary information may include dividing the received real-time broadcasting content into at least one form of data constituting the received real-time broadcasting content, extracting related information by extracting a characteristic from each form of data, and generating the program summary information by use of the extracted related information.

The divided data may include at least one of video data, audio data, and text data.

The text data may be a closed caption included in the real-time broadcasting content.

If the received real-time broadcasting content is divided into at least two forms of data, the program summary information may be generated by merging the at least two pieces of the extracted related information.

The program summary information generated through merging may be provided in a form of a still image or a moving image.

The real-time broadcasting content may be segmented into at least one semantic section by use of the extracted related information, and the program summary information may be generated for each segmented semantic section.

In still another aspect, there is provided an apparatus for generating program summary information corresponding to real-time broadcasting content, the apparatus including a tuner configured to receive the real-time broadcasting content, an information extraction unit configured to extract the program summary information from the received real-time broadcasting content, and a storage unit configured to store the extracted program summary information.

The apparatus may further include a display unit configured to display the received real-time broadcasting content and the program summary information.

The information extraction unit may include a demultiplexing unit configured to divide the received real-time broadcasting content into at least one form of data constituting the received real-time broadcasting content, and a related information extraction unit configured to extract related information by extracting a characteristic from each form of data.

The demultiplexing unit may divide the received real-time broadcasting content into at least one of video data, audio data, and text data, and the related information extraction unit may include a video related information extraction unit configured to extract information related to the video data, an audio related information extraction unit configured to extract information related to the audio data, and a text related information extraction unit configured to extract information related to the text data.

If the received real-time broadcasting content is divided into at least two forms of data, the information extraction unit may further include a related information merging unit configured to merge the at least two pieces of extracted related information.

The apparatus may further include a segmentation unit configured to segment the received broadcasting content into at least one semantic section by use of extracted related information, and the information extraction unit may be configured to generate the program summary information for each semantic section segmented by the segmentation unit.

In still another aspect, there is provided a method of providing program summary information in a broadcasting receiver that receives and displays real-time broadcasting content, the method including receiving a request for the program summary information regarding the received real-time broadcasting content, obtaining the program summary information corresponding to the request, and displaying the obtained program summary information.

The obtaining of the program summary information may include obtaining the program summary information from the broadcasting receiver, or a server connected to the broadcasting receiver through a network.

The obtaining of the program summary information may be performed by selecting program summary information generated before the request is received, among a plurality of program summary information regarding the real-time broadcasting content when the request is received.

The program summary information may be displayed on a frame different from a frame displaying the real-time broadcasting content.

In still another aspect, there is provided a broadcasting receiver for providing program summary information regarding real-time broadcasting content, the broadcasting receiver including a receiving unit configured to receive the real-time broadcasting content, a storage unit configured to store the program summary information, a display unit configured to output the program summary information, and a control unit configured to obtain the program summary information corresponding to a request and to output the corresponding program summary information on the display unit.

The control unit may allow the corresponding program summary information to be obtained from the storage unit, or a server connected to the broadcasting receiver through a network.

The control unit may be configured to output the program summary information by selecting program summary information generated before the request is received, among a plurality of program summary information regarding the real-time broadcasting content when the request is received.

Other features and aspects will be apparent from the following detailed description, the drawings, and the claims.

### BRIEF DESCRIPTION OF THE DRAWINGS

FIG. 1 is a diagram illustrating a configuration of a program summary information generating apparatus according to an example embodiment.

FIG. 2 is a diagram illustrating a configuration of an information extraction unit shown in FIG. 1.

FIG. 3 is a diagram illustrating an example of a program summary information generating method of the program summary information generating apparatus of FIG. 1.

FIG. 4 is a diagram illustrating a control flow of a program summary information extraction process of FIG. 3.

FIG. 5 is a diagram illustrating a configuration of a broadcast receiver for displaying real-time broadcasting content and program summary information, according to an example embodiment.

FIG. 6 is a diagram illustrating a process of providing program summary information to an operator such as a user or viewer.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

Hereinafter, examples will be described with reference to accompanying drawings.

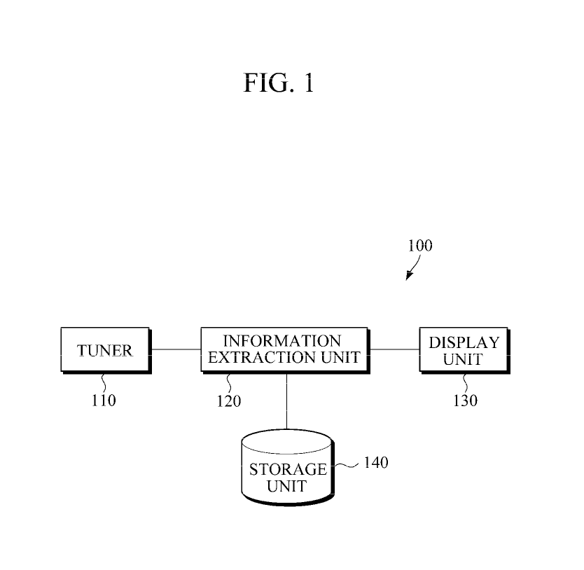

FIG. 1 shows an example of a program summary information generating apparatus 100.

As shown in FIG. 1, the program summary information generating apparatus 100 may include a tuner 110, an information extraction unit 120, a display unit 130, and a storage unit 140.

The tuner 110 receives real-time broadcasting content. The tuner 110 may be provided in various known or to be known forms corresponding to the transmission scheme of broadcasting contents. For example, various tuners may be used for individual transmission schemes including an analog broadcasting scheme, a digital broadcasting scheme, a satellite broadcasting scheme, a cable broadcasting scheme, a digital multimedia broadcasting scheme, and the like.

In the case of a broadcasting receiver such as a television, the number of channels simultaneously allowing broadcastings is determined depending on the number of tuners. A broadcasting receiver including a plurality of tuners has an ability to simultaneously receive a plurality of channels of broadcastings. To this end, the broadcasting receiver having a plurality of tuners may include a plurality of program summary information generating apparatuses. That is, a single program summary information generating apparatus 100 may analyze a single broadcasting content from received broadcasting contents and generate program summary information corresponding to the received single broadcasting content. Accordingly, in order to generate program summary information for individual channels broadcasted at the same time, a plurality of program summary information generating apparatuses may be used.

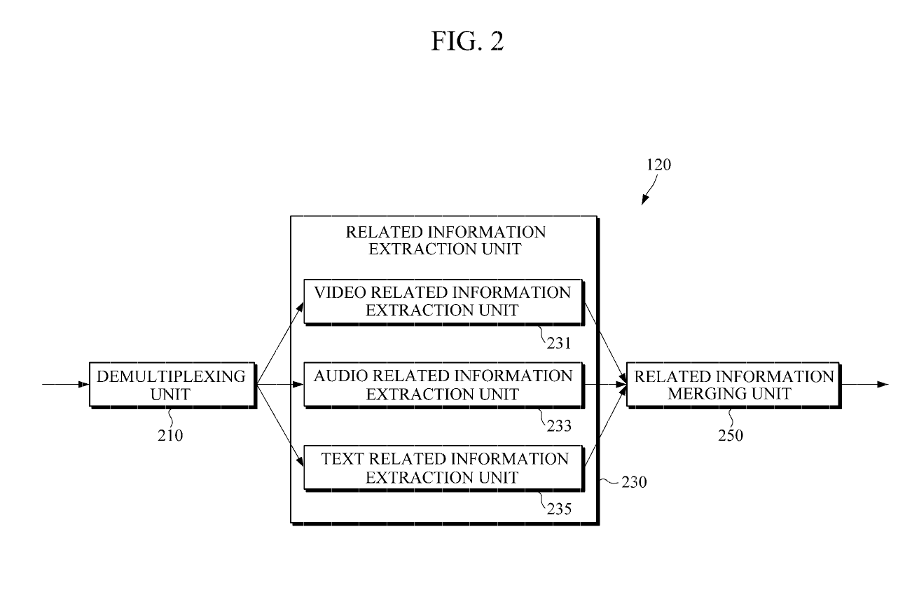

The information extraction unit 120 extracts program summary information by analyzing real-time broadcasting content received from the tuner 110. For example, the program summary information is information obtained by analyzing highlight scenes of the real-time broadcasting content, and a single piece of program summary information may be generated for each individual section of the real-time broadcasting content. The process of extracting program summary information will be further described with reference to FIG. 2.

The program summary information extracted from the information extraction unit 120 is stored in the storage unit 140. Although the storage unit 140 in FIG. 1 is shown as a part of the program summary information generating apparatus 100, in another implementation, the storage unit 140 may be separate from the program summary information generating apparatus 100. For example, the storage unit 140 may be provided as a unit that is connected to the program summary information generating apparatus 100 through a network.

The display unit 130 displays the program summary information that is generated from the information extraction unit 120. For example, the display unit 130 may be provided with a network interface allowing the program summary information to be provided when a request for the program summary information is received from a broadcasting receiver.

The program summary information generating apparatus 100 may be included in the broadcasting receiver or may be provided as a peripheral connected in close proximity to the broadcasting receiver. As another example, the program summary information generating apparatus 100 may be disposed remote to the broadcasting receiving apparatus as a separate unit and connected to the broadcasting receiver through a network.

For example, where the program summary information generating apparatus 100 is included in the broadcasting receiver or provided as a peripheral connected in close proximity to the broadcasting receiver, the program summary information generating apparatus 100 may be accommodated in a television or may be provided in the form of a set-top box connected to a television through wired/wireless schemes.

Where the program summary information generating apparatus 100 is disposed remote to the broadcasting receiver as a separate unit, in response to a request for program summary information, the program summary information generating apparatus 100 may search and communicate program summary information corresponding to the request to the broadcasting receiver through wired/wireless networks.

Accordingly, it is understood that the display unit 130 may be provided in various forms depending on the implementation of the program summary information generating apparatus 100.

As an example, where the program summary information generating apparatus 100 is included in the broadcasting receiver or implemented as a peripheral connected in close proximity to the broadcasting receiver, the display unit 130 may be combined with a display module for displaying real-time broadcasting content and program summary information. As a non-limiting illustration, the display module may be a liquid crystal display (LCD), a plasma display panel (PDP), a light emitting diode (LED), and the like, and may be provided as any other module capable of displaying program summary information.

As another example, where the program summary information generating apparatus 100 is disposed remote to the broadcasting receiver as a separate unit, the display unit 130 may be or instead be a transmission module for transmitting program summary information to the broadcasting receiver. In this case, the display unit 130 (or the transmission module) may include a network interface module capable of communicating with a broadcasting receiver remote to the display unit 130 (or the transmission module).

That is, the display unit 130 may be provided in various forms depending on the various examples of the program summary information generating apparatus 100 described above.

Although not shown in FIG. 1, the information extraction unit 120 may include a segmentation unit.

A segmentation unit may segment real-time broadcasting content into at least one semantic section such as a context of documents. The information extraction unit 120 may analyze a scene for each segmented semantic section, and extract program summary information for each semantic section. In this manner, various kinds of program summary information including a section summary video, a section topic and a main image may be generated for each section, so that a plurality of pieces of program summary information may be generated for a single real-time broadcasting content.

The segmentation unit may segment the real-time broadcasting content into at least one semantic section based on the similarity between scenes.

As an example, if real-time broadcasting content is a music broadcasting program, the program may be segmented into at least one section based on a singer appearing on the program, thereby generating program summary information for each singer. In this case, even if a user starts watching from the middle part of the program, the user may not find it difficult in figuring out which singers appeared prior to the current part of the program.

As another example, if real-time broadcasting content is a soap opera, the program may be divided into sections based on a highlight scene. The dividing of the program based on a highlight scene may be performed in consideration of various components such as the features of the scene and main characters appearing on the scene. In this manner, even if a user starts watching from the middle part of the program, the user may not find it difficult in figuring out the previous part of the soap opera, which may allow the user to be more easily absorbed into the soap opera.

FIG. 2 shows an example configuration of the information extraction unit 120 shown in FIG. 1.

The information extraction unit 120 may include a demultiplexing unit 210, a related information extraction unit 230 and a related information merging unit 250. As shown in FIG. 2, the related information extraction unit 230 may include a video related information extraction unit 231, an audio related information extraction unit 233 and a text related information extraction unit 235.

The demultiplexing unit 210 divides the real-time broadcasting content into at least one piece of data constituting the received real-time broadcasting content. That is, in general, data constituting real-time broadcasting content may be classified into video data, audio data, and text data. Accordingly, the demultiplexing unit 210 may divide the real-time broadcasting content into video data, audio data, and text data.

For example, the video data may represent color, texture, motion, and the like, and the audio data may represent the voice of a main character, background music, and the like, and the text data may represent subtitle information, closed captions, and the like.

That is, since the real-time broadcasting content may be formed as a combination having at least one of a scene (video data), sound (audio data) and characters (text data), the demultiplexing unit 210 divides the real-time broadcasting content into at least one form of data such as video data, audio data and text data, and transmits the divided data into the related information extraction unit 230.

The related information extraction unit 230 extracts related information from the data that is transmitted from the demultiplexing unit 210. For example, the related information may represent a single piece of information, such as a capture shot of a highlight scene, the name of a main character or sound made by animals, constituting the program summary information.

The related information may be of three types, video-related information related to video data, audio-related information related to audio data, and text-related information related to text data. Individual pieces of related information may be extracted from the video related information extraction unit 231, the audio related information unit 233 and the text related information unit 235.

The related information merging unit 250 may merge the individual pieces of related information extracted from the video related information extraction unit 231, the audio related information unit 233, and the text related information extraction unit 235 into a single piece of program summary information. For example, where the demultiplexing unit 210 divides the real-time broadcasting program into a plurality of pieces of data, a plurality of pieces of related information are extracted and the plurality of pieces of related information may be provided into a single piece of program summary information.

An example of a process of extracting related information will be described below.

It is assumed that the real-time broadcasting content is a music based broadcasting program, a singer ‘A’ (name) sings a song “Love” (title) on a scene represented in real time, and information regarding the singer and title is provided as closed captions for the hearing-impaired.

According to one example, in order to extract program summary information regarding the scene described above, the demultiplexing unit 210 divides the music based broadcasting program into video data, audio data, and text data.

The related information extraction unit 230 extracts characteristic data from the divided data which serves as related information. For example, the video related information extraction unit 231 may extract an image of the singer ‘A’ as related information, the audio-related information extraction unit 233 may extract a climax part of the song “Love” as related information, and the text related information extraction unit 235 may extract a text representing the singer ‘A’ as related information.

The related information merging unit 250 merges the above three types of related information extracted by the related information extraction unit 230, so as to generate the program summary information.

The program summary information extracted by the information extraction unit 120 may be a still image formed of a single frame or a moving image formed of a plurality of frames. It is understood that other forms can be provided, and the program summary information may be provided in various forms that represents information of the real-time broadcasting content.

As an example, a music based broadcasting program has been described as the real-time broadcasting content. However, it is understood that summary information can be generated for any other kind of real-time broadcasting content or any other content.

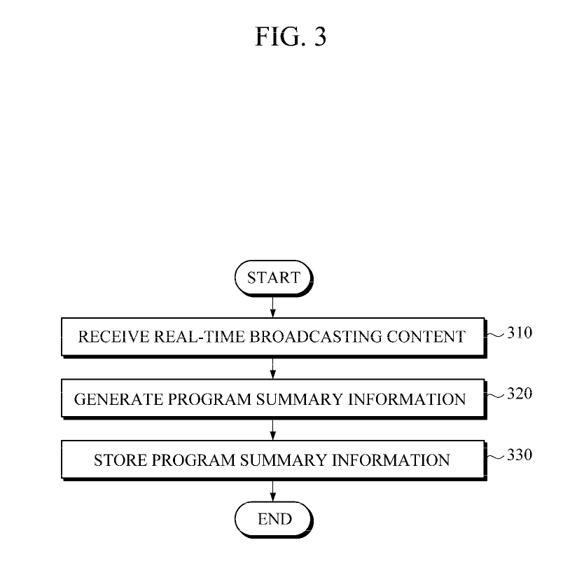

FIG. 3 shows an example of a program summary information generating method of a program summary information generating apparatus consistent with the disclosure provided herein, for example, the program summary information generating apparatus 100 of FIG. 1.

According to the example method, the program summary information generating apparatus 100 receives real-time broadcasting content (310). Then, the received real-time broadcasting content is analyzed to extract program summary information (320). The extracted program summary information is stored in the storage unit 140 (330). Since the description for receiving real-time broadcasting content and storing the extracted program summary information has been provided above with reference to FIGS. 1 and 2, a further description thereof will be omitted for conciseness. As discussed previously, the receiving of real-time broadcasting content may be achieved using a plurality of tuners and may be provided in various forms depending on the transmission scheme. In addition, the storage unit 140 may be included in the program summary information generating apparatus 100, or may be provided as a separate unit in proximity or remote to the program summary information generating apparatus 100 as described above.

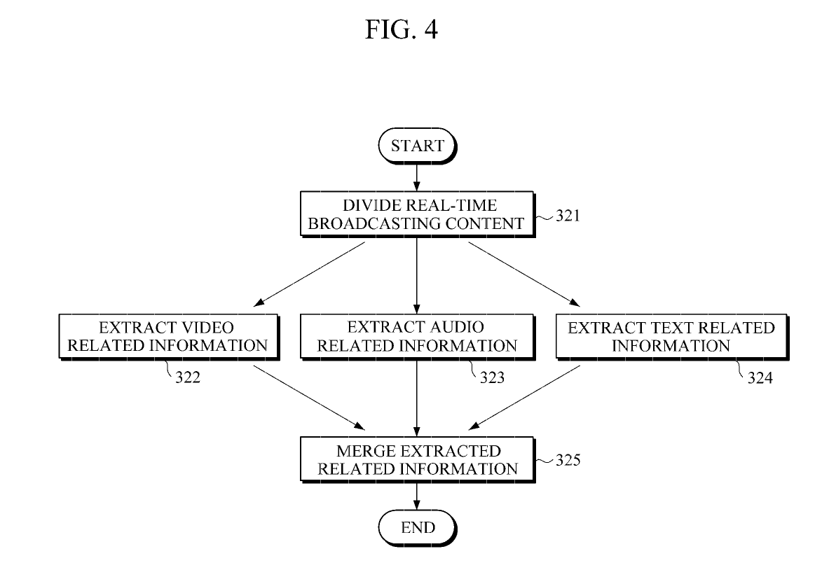

FIG. 4 shows an example of a control flow of a program summary information extraction process of FIG. 3.

The real-time broadcasting content is divided into at least one form of data constituting received real-time broadcasting content (321). Since the real-time broadcasting content may be formed of at least one of video data, audio data, and text data as described above with reference to FIG. 2, further description thereof will be omitted for conciseness. Thereafter, video-related information is extracted (322), audio-related information is extracted (323), and text-related information is extracted (324).

As an illustration, the real-time broadcasting content processed in FIG. 4 includes three types of data. However, real-time broadcasting content may include more or less. Accordingly, in the case where the extraction of program summary information is performed on real-time broadcasting content having less, for example, excluding a predetermined type of data, it is understood that an extraction process corresponding to the excluded data may be omitted.

Returning to FIG. 4, related information extracted through at least one of operations 322 to 324 are merged, so that program summary information is generated (325). In the case where the demultiplexing unit 210 produces at least two pieces of divided data, the program summary information generating method may further include merging related information corresponding to the at least two pieces of divided data. If there is no need for merging extracted related information, that is, if program summary information is generated without merging, operation 325 may be omitted.

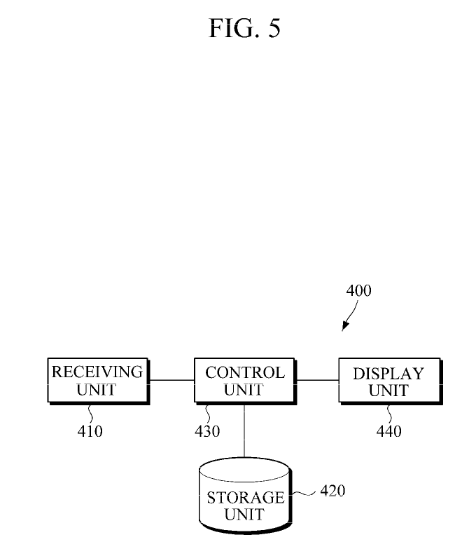

FIG. 5 shows an example of a broadcast receiver 400 for displaying real-time broadcasting content and program summary information.

The broadcasting receiver 400 may include a receiving unit 410, a storage unit 420, a control unit 430, and a display unit 440.

The broadcasting receiver 400 may be provided in various forms capable of displaying real-time broadcasting content and program summary information generated from a program summary information generating apparatus 100, for example, the broadcasting receiver 400 may be a television receiver.

As described with reference to FIG. 1, the broadcasting receiver 400 may include the program summary information generating apparatus 100 that generates program summary information by analyzing real-time broadcasting content. The program summary information generating apparatus 100 may be accommodated in the broadcasting receiver 400 or provided in the form of a set-top box connected to the broadcasting receiver 400 through wired/wireless schemes. That is, as an example, the broadcasting receiver 400 may be regarded as a comprehensive aspect including a television and a set-top box.

The receiving unit 410 receives real-time broadcasting content. The receiving unit 410 may have a configuration including a tuner.

The storage unit 420 stores program summary information. The program summary information may be generated from the program summary information generating apparatus 100.

In one case where the program summary information generating apparatus 100 is a part of the broadcasting receiver 400, program summary information extracted from the information extraction unit 120 may be stored in the storage unit 420 under the control of the control unit 430.

In another case where the program summary information generating apparatus 100 is provided as a separate unit from that of the broadcasting receiver 400, the broadcasting receiver 400 receives the program summary information transmitted from the program summary information generating apparatus 100 and stores the program summary information in the storage unit 420.

The display unit 440 displays the real-time broadcasting content and the program summary information. The real-time broadcasting content and the program summary information may be simultaneously displayed and may be displayed in various forms.

As an example, the program summary information may be displayed on a region different from a region displaying the real-time broadcasting content. That is, the program summary information may be displayed on a lower portion of the display unit 140 and the real-time broadcasting content may be displayed on an upper portion of the display unit 140.

As another example, the program summary information may be displayed on a region that overlaps a region displaying the real-time broadcasting content. That is, the program summary information may be displayed on a region displaying the real-time broadcasting content while overlapping the real-time broadcasting content.

As a non-limiting example only, the display unit 440 may be a liquid crystal display (LCD), a plasma display panel (PDP), a light emitting diode (LED), and the like.

The control unit 430 may control the receiving unit 410, the storage unit 420, and the display unit 440 each serving as a part of the broadcasting receiver 400.

The control unit 430 may identify program summary information requested by a user, and control to extract and provide the corresponding program summary information to the user.

In addition, the control unit 430 may perform control operations such that the extracted program summary information from the storage unit 420 is displayed on the display unit 440. For example, if the user makes a request for program summary information corresponding to ‘A,’ the control unit 430 may perform control operations such that the program summary information ‘A’ is found among a number of program summary information in the storage unit 420 and that the program summary information ‘A’ is displayed on the display unit 440.

According to one example of extracting program summary information requested by a user, real-time broadcasting content being displayed at a time when the request is made by the user is identified, and the program summary information, generated before the request is made, is selected and extracted among all or a plurality of program summary information regarding the identified real-time broadcasting content.

According to another example of extracting program summary information requested by a user, program summary information generated before the broadcasting receiver 400 is turned on is selected and extracted other than program summary information generated before the request is made.

That is, in the former example, the user may receive program summary information that is generated prior to the user requesting the program summary information. In the latter example, the user may receive program summary information corresponding to a part of the real-time broadcasting content which the user may fail to watch.

In addition, the control unit 430 may determine whether program summary information requested by a user is stored in the storage unit 420. If the requested program summary information is stored in the storage unit 420, the control unit 430 may perform control operations such that the program summary information is displayed on the display unit 440.

Meanwhile, if the requested program summary information is not stored in the storage unit 420, the control unit 430 may perform control operations such that the receiving unit 410 receives program summary information corresponding to the request from the program summary information generating apparatus 100 that is, for example, disposed remote to the broadcasting receiver 400, and that the received program summary information is displayed on the display unit 440.

For example, if the program summary information generating unit 100 is disposed remote to the broadcasting receiver 400, the control unit 430 may perform control operations with respect to a communication unit (not shown) of the broadcasting receiver 400 such that the broadcasting receiver 400 is connected to the program summary information generating unit 100 through a network to receive the program broadcast information corresponding to the request to made by the user

The control unit 430 may also perform control operations such that program summary information is selectively obtained from the storage unit 420.

According to one example of obtaining program summary information requested by a user, the control unit 430 may identify real-time broadcasting content that is being displayed at the moment when a request is received, and select and obtain program summary information, generated before the request is made, among all or a plurality of program summary information of the identified real-time content.

According to another example of obtaining program summary information requested by a user, the control unit 430 may perform control operations such that program summary information, generated before the broadcast receiving apparatus 400 is turned on, is selected and obtained other than program summary information generated before the request is made.

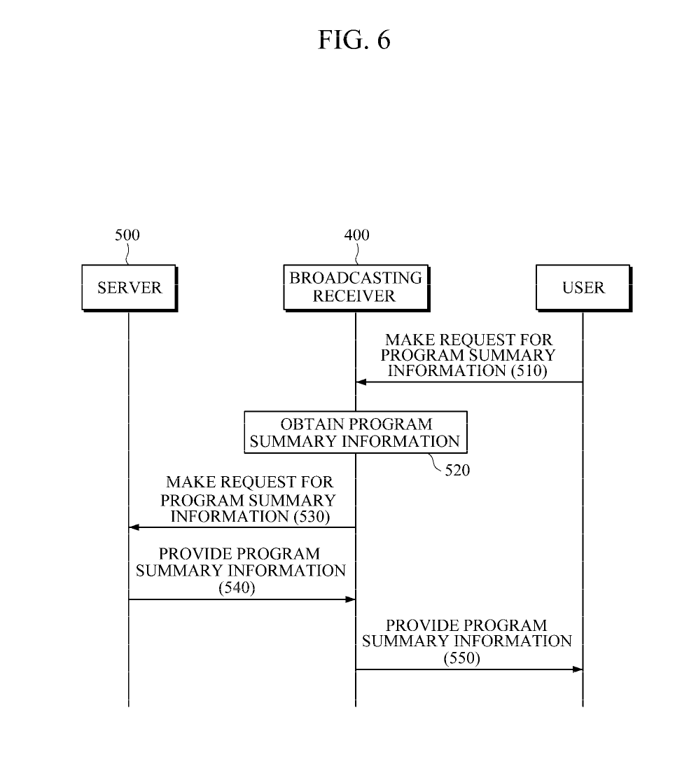

FIG. 6 shows an example process of providing program summary information to a user.

With reference to FIGS. 1-5, the broadcasting receiver 400 receives a request for program summary information from a user (510).

The user may request for program summary information to the broadcasting receiver 400 in various cases. As one example, when a user turns the broadcasting receiver 400 on or changes a channel of the broadcasting receiver 400, and real-time broadcasting content is currently at the middle part thereof and the user wants to figure out about the previous part of the broadcasting content, the user may make a request for program summary information regarding the previous part.

As another example, while the user is watching real-time broadcasting content of an ‘A’ channel, and the user wants to figure out about the details for a broadcasting content of a ‘B’ channel, the user may make a request for program summary information regarding the ‘B’ channel.

The broadcasting receiver 400 having received the request for the program summary information from the user obtains program summary information corresponding to the request (520).

For example, a method of obtaining the program summary information may vary depending on whether program summary information corresponding to the request is stored in the broadcasting receiver 400.

Where the corresponding program summary information is stored in the broadcasting receiver 400, the broadcasting receiver 400 reads the corresponding program summary information from the storage unit 420 and displays the program summary information on the display unit 440, thereby providing the program summary information to the user (550).

Meanwhile, if the corresponding program summary information is not stored in the broadcasting receiver 400, the broadcasting receiver 400 transmits a request for program summary information to a server 500 (530). If the server 500 provides program summary information in response to the request (540), the broadcasting receiver 400 receives the program summary information and provides the program summary information to the user (550).

In this case, the broadcasting receiver 400 may be connected to the server 500 through a network. The server 500 represents a separate unit which is remote to the broadcasting receiver 400, and may receive and analyze real-time broadcasting content received from the broadcasting receiver 400. That is, the server 500 may be the program summary information generating apparatus 100 as described above with reference to FIG. 1.

In the case where program summary information corresponding to the request is stored in the broadcasting receiver 400, it is understood that operations 530 and 540 may be omitted.

The broadcasting receiver 400 may selectively obtain program summary information in operation 520. As examples of selectively obtaining program summary information, program summary information, generated before the request is made, may be obtained, or program summary information, generated before the broadcasting receiver 400 is turned on, may obtained. Descriptions of the selectively obtaining of program summary information have been described above, and it is understood that the selectively obtaining of program summary information may be implemented in various forms depending on other criteria.

In the providing of the obtained program summary information to the user, the obtained program summary information may be provided together with the real-time broadcasting content. The program summary information and the related real-time broadcasting content may be displayed on different regions or using different forms as described above with reference to FIG. 5.

According to the certain examples described above, as non-limiting examples, real-time broadcasting content may refer to: “LIVE” content from studio broadcasted and received by, for example, a television, such as live talk show aired, for example, 8:00 PM seen by the viewers at about the same time; pre-recorded content broadcasted and received in real-time by, for example, a television, such as a show recorded, for example, 6:00 AM, but aired later at, for example, 8:00 PM and seen by the viewers at about the same time of the airing; and content recorded in a media, for example, DVD, played on a television, such that while a viewer #1 has started and viewed the content from the start, a viewer #2 has walked in, and for example, started to watch from the middle of the program.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of generating program summary information in a program summary information generating apparatus including at least one tuner, the method comprising:
receiving real-time broadcasting content through the tuner;
extracting the program summary information from the received real-time broadcasting content; and
storing the extracted program summary information.

2. The method of claim 1, wherein, the extracting of the program summary information comprises:
dividing the received real-time broadcasting content into at least one form of data constituting the received real-time broadcasting content;
extracting related information by extracting a characteristic from each form of data; and
generating the program summary information by use of the extracted related information.

3. The method of claim 2, wherein the divided data includes at least one of video data, audio data, and text data.

4. The method of claim 3, wherein the text data is a closed caption included in the real-time broadcasting content.

5. The method of claim 2, wherein, if the received real-time broadcasting content is divided into at least two forms of data, the program summary information is generated by merging the at least two pieces of the extracted related information.

6. The method of claim 5, wherein the program summary information generated through merging is provided in a form of a still image or a moving image.

7. The method of claim 2, wherein the real-time broadcasting content is segmented into at least one semantic section by use of the extracted related information, and
the program summary information is generated for each segmented semantic section.

8. An apparatus for generating program summary information corresponding to real-time broadcasting content, the apparatus comprising:
a tuner configured to receive the real-time broadcasting content;
an information extraction unit configured to extract the program summary information from the received real-time broadcasting content; and
a storage unit configured to store the extracted program summary information.

9. The apparatus of claim 8, further comprising a display unit configured to display the received real-time broadcasting content and the program summary information.

10. The apparatus of claim 8, wherein the information extraction unit comprises:
a demultiplexing unit configured to divide the received real-time broadcasting content into at least one form of data constituting the received real-time broadcasting content; and
a related information extraction unit configured to extract related information by extracting a characteristic from each form of data.

11. The apparatus of claim 10, wherein the demultiplexing unit divides the received real-time broadcasting content into at least one of video data, audio data, and text data, and the related information extraction unit comprises:
a video related information extraction unit configured to extract information related to the video data;
an audio related information extraction unit configured to extract information related to the audio data; and
a text related information extraction unit configured to extract information related to the text data.

12. The apparatus of claim 10, wherein, if the received real-time broadcasting content is divided into at least two forms of data, the information extraction unit further comprises a related information merging unit configured to merge the at least two pieces of extracted related information.

13. The apparatus of claim 10, further comprising a segmentation unit configured to segment the received broadcasting content into at least one semantic section by use of extracted related information, and
the information extraction unit is configured to generate the program summary information for each semantic section segmented by the segmentation unit.

14. A method of providing program summary information in a broadcasting receiver that receives and displays real-time broadcasting content, the method comprising:
receiving a request for the program summary information regarding the received real-time broadcasting content;
obtaining the program summary information corresponding to the request; and
displaying the obtained program summary information.

15. The method of claim 14, wherein, the obtaining of the program summary information comprises obtaining the program summary information from the broadcasting receiver, or a server connected to the broadcasting receiver through a network.

16. The method of claim 14, wherein, the obtaining of the program summary information is performed by selecting program summary information generated before the request is received, among a plurality of program summary information regarding the real-time broadcasting content when the request is received.

17. The method of claim 14, wherein the program summary information is displayed on a frame different from a frame displaying the real-time broadcasting content.

18. A broadcasting receiver for providing program summary information regarding real-time broadcasting content, the broadcasting receiver comprising:
a receiving unit configured to receive the real-time broadcasting content;
a storage unit configured to store the program summary information;
a display unit configured to output the program summary information; and
a control unit configured to obtain the program summary information corresponding to a request and to output the corresponding program summary information on the display unit.

19. The broadcasting receiver of claim 18, wherein the control unit allows the corresponding program summary information to be obtained from the storage unit, or a server connected to the broadcasting receiver through a network.

20. The broadcasting receiver of claim 18, wherein the control unit is configured to output the program summary information by selecting program summary information generated before the request is received, among a plurality of program summary information regarding the real-time broadcasting content when the request is received.
